(19) United States
(12) Patent Application Publication
(10) Pub. No.: US 2006/0270363 A1
(43) Pub. Date: Nov. 30, 2006

(54) Method and apparatus for implementing cooperative diversity using partial channel knowledge

(75) Inventors: Sumeet Sandhu, San Jose, CA (US); Prasanna G. Mulgaonkar, Saratoga, CA (US)

Correspondence Address: The Law Offices of John C. Scott, LLC;c/o PortfolioIP, P.O. Box 52050, Minneapolis, MN, 55402, US

(73) Assignee: Intel Corporation

(21) Appl. No.: 11/132,588

(22) Filed: May 19, 2005

(51) Int. Cl. H04B 1/02

(52) U.S. Cl. 455/101

(57) ABSTRACT

Partial channel information is used to weight signals being transmitted by cooperating nodes within a cooperative diversity arrangement. In at least one embodiment, the phase of the complex conjugate of a channel coefficient between a cooperating node and a remote device is used to weight a transmit signal.

### TECHNICAL FIELD

The invention relates generally to wireless communications and, more particularly, to wireless systems using cooperative diversity.

### BACKGROUND OF THE INVENTION

Cooperative diversity is a technique in which a number of independent wireless devices cooperate to act as a virtual antenna array to perform a particular communication task. Cooperative diversity may be used, for example, to increase the range between a source device and a destination device in a network by providing a number of simultaneously cooperating relay nodes between the source and destination devices. Cooperative diversity may also be used to achieve spatial transmit diversity in a system where single antenna devices are being used. Other applications also exist. There is a general need for techniques and structures for effectively implementing cooperative diversity in a wireless system.

### BRIEF DESCRIPTION OF THE DRAWINGS

FIGS. 1 and 2 are block diagrams illustrating a cooperative diversity arrangement that may utilize features of the present invention;

FIG. 3 is a block diagram illustrating another example cooperative diversity arrangement that may utilize features of the invention;

FIG. 4 is a flowchart illustrating a method for use in relaying signals between a source node and a destination node in a wireless network using cooperative diversity in accordance with an embodiment of the present invention;

FIG. 5 is a flowchart illustrating a method for use in connection with a wireless device that is being used as a cooperating node within a cooperative diversity network arrangement in accordance with an embodiment of the present invention; and

FIG. 6 is a block diagram illustrating a wireless device that may be used as a cooperating node within a cooperative diversity arrangement in accordance with an embodiment of the present invention.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

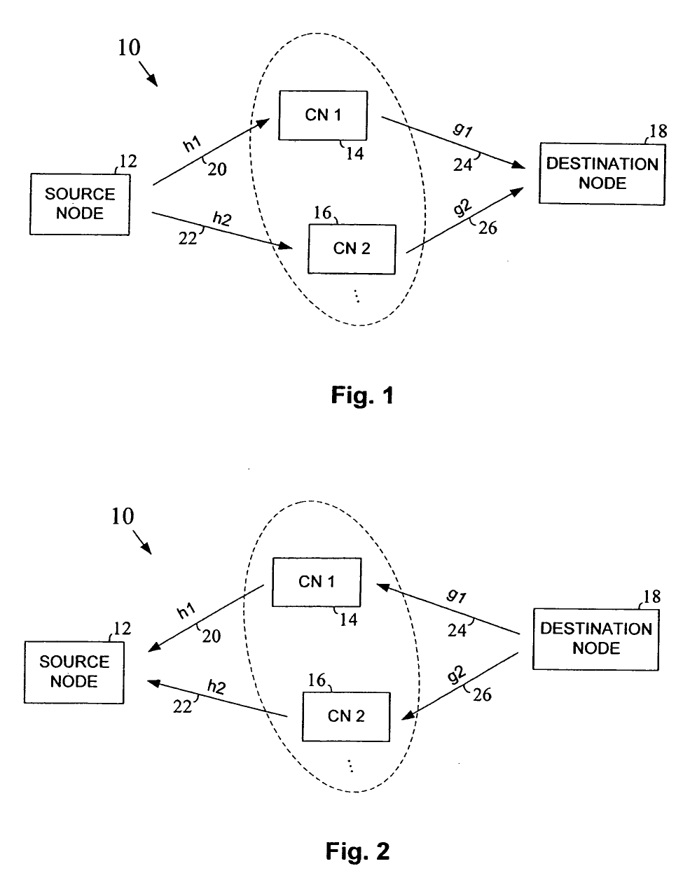

FIG. 1 is a block diagram illustrating a cooperative diversity arrangement 10 that may utilize features of the present invention. As shown, the cooperative diversity arrangement 10 may include: a source node 12, a destination node 18, and first and second cooperating nodes 14, 16. The source node 12 may desire to transmit a signal to the destination node 18, but the destination node 18 may be out of range of the source node 12. The cooperating nodes 14, 16 may therefore be used as a relay between the source node 12 and the destination node 18. A dotted line is used within FIG. 1 and in other figures herein to denote the cooperative nature of the corresponding nodes. Although illustrated with two cooperating nodes 14, 16 in FIG. 1, it should be appreciated that any number of cooperating nodes may be used within a cooperative diversity arrangement. In the discussion that follows, however, it will be assumed that two cooperating nodes are being used.

The wireless nodes 12, 14, 16, 18 within the cooperative diversity arrangement 10 of FIG. 1 may include any type of wireless devices, systems, or components that are capable of wirelessly communicating with one another. In one scenario, for example, the source node 12 may be a television set having wireless networking capability, the destination node 18 may be a printer having wireless networking capability, the first cooperating node 14 may be a video camera having wireless networking capability, and the second cooperating node 16 may be a video game having wireless networking capability. The television set may wish to print information on the printer which is located in another part of a residence, out of range of the television set. The video camera and the video game may then be called upon to act cooperatively to form a relay between the television and the printer. As will be appreciated, a wide variety of different network scenarios may exist involving a wide variety of different wireless node types.

During operation, the source node 12 transmits a forward signal to the first and second cooperating nodes 14, 16. In FIG. 1, the channel 20 between the source node 12 and the first cooperating node 14 is labeled h1 and the channel 22 between the source node 12 and the second cooperating node 16 is labeled h2. After receiving the forward signal, the cooperating nodes 14, 16 each retransmit the forward signal to the destination device 18. As shown in FIG. 1, the channel 24 between the first cooperating node 14 and the destination node 18 is labeled g1 and the channel 26 between the second cooperating node 16 and the destination node 18 is labeled g2. The first and second cooperating nodes 14, 16 may each encode the forward signal using a space-time diversity coding scheme (e.g., the Alamouti code, etc.) before the signal is retransmitted to the destination node 18. The destination node 18 may thus benefit from higher order diversity resulting from independent fading from the multiple cooperating nodes 14, 16.

After the forward signal has been received, the destination node 18 may transmit a reverse signal back to the source node 12, via the cooperating nodes 14, 16 (see FIG. 2). The destination node 18 first transmits the reverse signal to the first and second cooperating nodes 14, 16 via corresponding wireless channels 24, 26. It is assumed that the various channels h1, h2, g1, g2 are all reciprocal, calibrated, and time-invariant. The first and second cooperating nodes 14, 16 then each transmit the reverse signal back to the source node 12 through corresponding channels 20, 22. However, instead of using a space-time diversity code as in the forward direction, the first and second cooperating nodes 14, 16 utilize partial channel information to weight the reverse signal before transmitting the signal in accordance with one aspect of the present invention. In at least one embodiment, the partial channel information that is used to weight the reverse signal for a particular cooperating node is the phase of the complex conjugate of the channel coefficient for the corresponding channel. Thus, the first cooperating node 14 will determine the conjugated phase of the channel coefficient for the channel 20 and use it to weight the reverse signal and the second cooperating node 16 will determine the conjugated phase of the channel coefficient for the channel 22 and use it to weight the reverse signal. The first and second cooperating nodes 14, 16 will then transmit their respective weighted reverse signals at substantially the same time. The magnitudes of the channel coefficients for the channels 20, 22 are not utilized in the weighting. Therefore, the first and second cooperating nodes 14, 16 may each transmit the weighted reverse signal at a maximum available transmit power (although this is not required). One advantage of using partial channel knowledge, rather then full channel knowledge, is that it can often be collected at a lower expenditure of overhead resources (e.g., bandwidth, power, etc.).

The partial channel knowledge used by the first and second cooperating nodes 14, 16 may be obtained in a variety of different ways. In one possible approach, for example, the source node 12 may deliver training data to each of the cooperating nodes 14, 16 within a transmitted frame (e.g., as part of the forward signal). The cooperating nodes 14, 16 then each use the received training data to calculate a complex channel coefficient for the channel between the cooperating node and the source node 12. The phase of the complex conjugate of the channel coefficient may then be calculated and stored in a memory for later use as a weighting factor for the node. This technique may be used because it is assumed that each channel is reciprocal. In another technique, each cooperating node 14, 16 can transmit training data to the source node 12 for use in developing partial channel information. The source node 12 may then transmit the partial channel information back to the cooperating nodes 14, 16 for later use. Other techniques for developing partial channel information for use by the cooperating nodes 14, 16 may alternatively be used.

In at least one embodiment, the cooperating nodes within a cooperative diversity arrangement (e.g., the first and second cooperating nodes 14, 16 in FIGS. 1 and 2) may communicate with one another during network operation to, among other things, coordinate the cooperative diversity function. A higher level protocol may be used to determine which devices in a network environment will cooperate in any given scenario to perform a desired function (e.g., to relay data between a source node and a destination node, etc.). One or more synchronization techniques may be employed during cooperative operation to synchronize the cooperating nodes. In at least one embodiment of the invention, the various nodes of a cooperative diversity arrangement will communicate with one another using time-division duplexing techniques. Other communication techniques may alternatively be used.

With reference to FIG. 2, assume that the destination node 18 transmits a signal u to the cooperating nodes 14, 16 for relay to the source node 12. Let X be the vector of signals transmitted by the cooperating nodes 14, 16 to the source node 12. This may be expressed as:

$$X = [ \begin{matrix}{X}_{1} \\ {X}_{2}\end{matrix} ]$$

for a situation where two cooperating nodes are present, where X₁ is the signal transmitted by the first cooperating node and X₂ is the signal transmitted by the second cooperating node. X is a function of u. If there are M cooperating nodes, the input/output equation between the cooperating nodes and the source node 12 may be expressed as follows:
y=HX+n=[h₁ . . . h_{M}]X+n
wherein h₁ . . . h_{M} are the channel coefficients for the channels associated with the M cooperating nodes and n is the thermal noise. As described above, each of the cooperating nodes weights the signal u to be transmitted to the source node by the phase of the complex conjugate of the associated channel coefficient. This may be expressed as follows:

$$X = ∠ H * u = [ \begin{matrix}exp ( - j {θ}_{1} ) \\ ⋮ \\ exp ( - j {θ}_{M} )\end{matrix} ] u = [ \begin{matrix}{h}_{1}^{*} / \vert {h}_{1} \vert \\ ⋮ \\ {h}_{M}^{*} / \vert {h}_{M} \vert\end{matrix} ] u$$

where exp(−jθ₁)=h₁*/|h₁| is the phase of the complex conjugate of the channel coefficient for the first cooperating node, and so on. By substituting this equation into the previous equation, the following expression is achieved:

$$\begin{matrix}y = H ∠ H * u + n \\ = [ \begin{matrix}{h}_{1} & ⋯ & {h}_{M}\end{matrix} ] [ \begin{matrix} {h}_{ 1}^{*} / \vert {h}_{ 1} \vert \\ ⋮ \\ {h}_{ M}^{*} / \vert {h}_{ M} \vert\end{matrix} ] u + n \\ = {\sum }_{m = 1}^{M} \vert {h}_{m} \vert u + n \\ = {‖ H ‖}_{1} u + n\end{matrix}$$

where ∥H∥₁ u is the 1-norm of H. The receive signal-to-noise ratio (SNR) for this transmit scheme is proportional to the squared 1-norm of H as follows:
SNR_{partial-knowledge}=∥H∥₁²Eₛ/N₀
where Eₛ is the symbol energy and No is the noise power spectral density. It can be shown that the receive SNRs that may be achieved using partial channel knowledge as described above are close to those that may be achieved using full channel knowledge. In addition, the receive SNRs using partial channel knowledge may be significantly larger than those that can be achieved using open loop space-time diversity techniques (which use no channel knowledge at the transmitter), such as Alamouti coding.

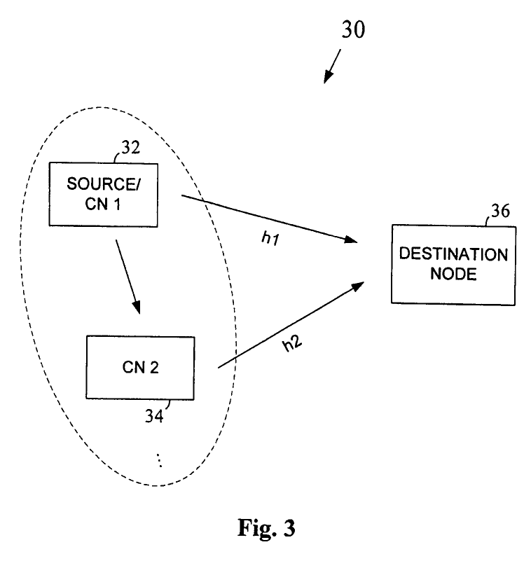

The above-described techniques using partial channel knowledge are not limited to use in cooperative diversity scenarios where the cooperating nodes are being used as relay devices. On the contrary, the techniques may be used in any situation where multiple nodes are cooperating to act as a virtual antenna array. For example, FIG. 3 is a block diagram illustrating another example cooperative diversity arrangement 30 that may utilize features of the invention. As shown, a source node 32 may desire to transmit a signal to a destination node 36. Instead of transmitting the data alone, the source node 32 may enter a cooperative diversity relationship with another node 34 to cooperatively transmit the signal. The source node 32 may first transmit the signal to the cooperating node 34 via a direct channel therewith. The source node 32 (which is also the first cooperating node) and the cooperating node 34 may then transmit the signal simultaneously to the destination node 36. As described above, the source node 32 and the cooperating node 34 may each weight the signal using the phase of the complex conjugate of the corresponding channel coefficient. Any number of different techniques may be used to acquire the partial channel knowledge required to perform the weighting. As before, the magnitudes of the channel coefficients are not used during the weighting. The source node 32 and the cooperating node 34 may each transmit the signal using full available transmit power (although this is not required). Because there are two cooperating nodes transmitting the signal to the destination node 36, a larger transmission range is possible. In addition, because the signal is being transmitted from multiple locations, spatial diversity is achieved for overcoming the effects of multipath fading. Although illustrated with only two cooperating nodes, it should be understood that any number of cooperating nodes may be used in the arrangement 30 of FIG. 3. Other cooperative diversity configurations may alternatively be used in accordance with the present invention.

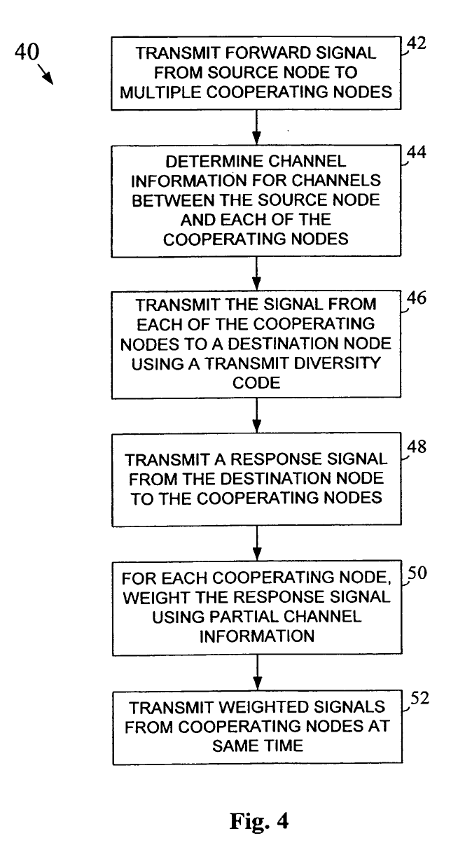

FIG. 4 is a flowchart illustrating a method 40 for use in relaying signals between a source node and a destination node in a wireless network using cooperative diversity in accordance with an embodiment of the present invention. The method 40 may be used, for example, within the cooperative diversity arrangement 10 of FIGS. 1 and 2 and in other cooperative diversity arrangements. First, a forward signal is transmitted from the source node to multiple cooperating nodes (block 42). Channel information is determined for channels between the source node and each of the cooperating nodes (block 44). This channel information may be determined using training data received at the cooperating nodes from the source node or in some other manner. The forward signal may then be encoded in each of the cooperating nodes using a space-time diversity code (e.g., Alamouti, etc.) and transmitted to the destination node (block 46). If the destination node wishes to respond, the destination node transmits a response signal to the multiple cooperating nodes (block 48). Each of the cooperating nodes then receives the response signal and weights it using partial channel information for a corresponding channel between the cooperating node and the source node (block 50). As described previously, in at least one embodiment, the partial channel information for a particular cooperating node includes the phase of the complex conjugate of the corresponding channel coefficient between the cooperating node and the source node. The weighted signals are subsequently transmitted from the cooperating nodes at substantially the same time (block 52). In at least one embodiment, the weighted signals are transmitted from each the cooperating nodes at a maximum available power. In other embodiments, other transmit power levels may be used.

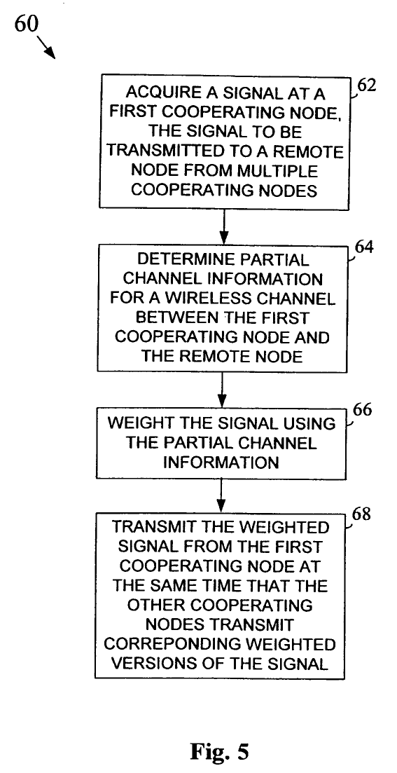

FIG. 5 is a flowchart illustrating a method 60 for use in connection with a wireless device that is acting as a cooperating node within a cooperative diversity arrangement in accordance with an embodiment of the present invention. The method 60 may be practiced in connection with, for example, the cooperating nodes 14 and 16 of FIGS. 1 and 2, the cooperating nodes 32 and 34 of FIG. 3, or cooperating nodes in any other network arrangement where multiple nodes are cooperating to form a virtual antenna array. A first cooperating node acquires a signal that is to be transmitted to a remote node from the first cooperating node and other cooperating nodes (block 62). Partial channel information is determined for a channel between the first cooperating node and the remote node (block 64). This information may be determined in any manner. The signal is then weighted within the first cooperating node using the partial channel information (block 66). The weighted signal is subsequently transmitted by the first cooperating node at substantially the same time that the other cooperating nodes within the cooperative arrangement transmit their weighted versions of the signal (block 68).

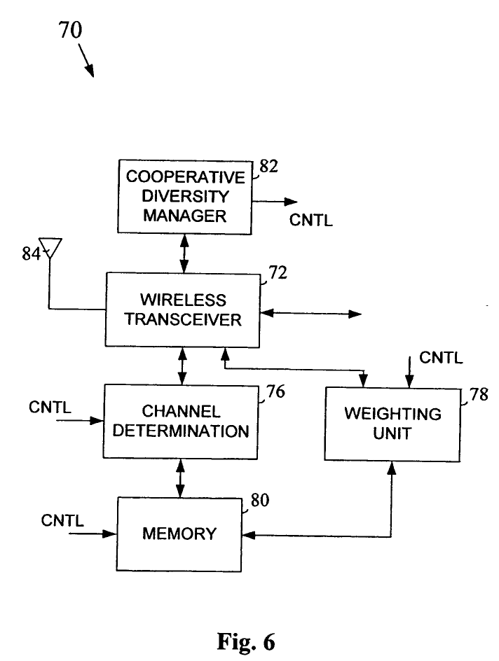

FIG. 6 is a block diagram illustrating functionality within a wireless device 70 that may be used as a cooperating node within a cooperative diversity arrangement in accordance with an embodiment of the present invention. As shown, the wireless device 70 may include: a wireless transceiver 72, a channel determination unit 76, a weighting unit 78, a memory 80, and a cooperative diversity manager 82. The wireless transceiver 72 is operative for transmitting wireless signals to, and receiving wireless signals from, one or more remote wireless entities. The wireless transceiver 72 may be coupled to one or more antennas 84 to facilitate the transmission and reception of signals. Any type of antenna(s) may be used including, for example, a dipole, a patch, a helical antenna, a loop antenna, and/or others. The wireless transceiver 72 may be configured for operation in accordance with one or more wireless communication standards (e.g., wireless networking standards, wireless cellular standards, etc.). The channel determination unit 76 is operative for acquiring partial channel information for a wireless channel between the wireless device 70 and a remote device when the wireless device 70 is acting as a cooperating node within a cooperative diversity arrangement. The channel determination unit 76 may acquire the partial channel information in any of a variety of different manners. In one embodiment, for example, the channel determination unit 76 uses training data received from the remote device to develop the partial channel information. In another approach, the channel determination unit 76 may simply receive the partial channel information from the remote device. Other techniques for acquiring the partial channel information may alternatively be used. The memory 80 may be used to store the partial channel information until needed by the wireless device 70. The weighting unit 78 may be used to weight a signal to be transmitted to a remote wireless device. The weighting unit 78 may retrieve the partial channel information from the memory 80 for use in performing the weighting function. The weighted signal may then be transmitted by the wireless transceiver 72 to the remote device.

The cooperative diversity manager 82 is operative for managing the performance of cooperative diversity functions for the wireless device 70. The cooperative diversity manager 82 may first determine that the device 70 is being used as a cooperating device within a cooperative diversity arrangement and then manage the operation of the device 70 in an appropriate manner. For example, the cooperative diversity manager 82 may determine that the wireless device 70 is acting as a cooperating device to provide a relay of information between a source node and a destination node. The cooperative diversity manager 82 may then cause signals being transferred from the destination node to the source node to be weighted with partial channel information and transmitted at an appropriate time. The cooperative diversity manager 82 may also be operative for maintaining synchronization with the other cooperating devices and for maintaining any other conditions required for cooperative operation. The cooperative diversity manager 82 may operate in conjunction with a higher level cooperative diversity protocol.

In the various embodiments described above, features of the invention are described in the context of a single carrier wireless system. It should be appreciated, however, that the invention may also be practiced in multi-carrier systems (e.g., systems using orthogonal frequency division multiplexing (OFDM), etc.). This will typically require the performance of various acts separately for each of the relevant subcarriers of the system. For example, partial channel information may be determined for a channel between a cooperating device and a remote device for each of a plurality of subcarriers in a system, a signal may be weighted using partial channel information for each of a plurality of subcarriers, and so on. Interpolation between subcarriers may be implemented to reduce the amount of computation involved.

In order to reduce feedback overhead, the phase on each frequency carrier may be quantized. For example, phase may be quantized to 6 sectors between 0 and 360 degrees. In order to improve phase synchronization between independent devices, precision location methods may be used to estimate exact distances between nodes.

The techniques and structures of the present invention may be implemented in any of a variety of different forms. For example, features of the invention may be embodied within laptop, palmtop, desktop, and tablet computers having wireless capability; personal digital assistants (PDAs) having wireless capability; cellular telephones and other handheld wireless communicators; pagers; cameras having wireless capability; audio/video devices having wireless capability; entertainment devices having wireless capability; printers and other computer peripherals having wireless capability; household appliances having wireless capability; wireless network interface cards (NICs) and other network interface structures; radio frequency identification (RFID) tags; sensors; integrated circuits; as instructions and/or data structures stored on machine readable media; and/or in other forms. Examples of different types of machine readable media that may be used include floppy diskettes, hard disks, optical disks, compact disc read only memories (CD-ROMs), magneto-optical disks, read only memories (ROMs), random access memories (RAMs), erasable programmable ROMs (EPROMs), electrically erasable programmable ROMs (EEPROMs), magnetic or optical cards, flash memory, and/or other types of media suitable for storing electronic instructions or data. In at least one form, the invention is embodied as a set of instructions that are modulated onto a carrier wave for transmission over a transmission medium.

It should be appreciated that the individual blocks illustrated in the block diagrams herein may be functional in nature and do not necessarily correspond to discrete hardware elements. For example, in at least one embodiment, two or more of the blocks in a block diagram are implemented in software within a single digital processing device. The digital processing devices may include, for example, a general purpose microprocessor, a digital signal processor (DSP), a reduced instruction set computer (RISC), a complex instruction set computer (CISC), a field programmable gate array (FPGA), an application specific integrated circuit (ASIC), and/or others, including combinations of the above. Hardware, software, firmware, and hybrid implementations may be used.

In the foregoing detailed description, various features of the invention are grouped together in one or more individual embodiments for the purpose of streamlining the disclosure. This method of disclosure is not to be interpreted as reflecting an intention that the claimed invention requires more features than are expressly recited in each claim. Rather, as the following claims reflect, inventive aspects may lie in less than all features of each disclosed embodiment.

Although the present invention has been described in conjunction with certain embodiments, it is to be understood that modifications and variations may be resorted to without departing from the spirit and scope of the invention as those skilled in the art readily understand. Such modifications and variations are considered to be within the purview and scope of the invention and the appended claims.

What is claimed is:

1. A method for use in a cooperative diversity arrangement having a plurality of cooperating nodes, comprising:
determining a conjugated phase of a channel coefficient for a channel between a first cooperating node and a remote node;
weighting a signal to be transmitted to said remote node from said first cooperating node using said conjugated phase of said channel coefficient, but not a magnitude of said channel coefficient, to generate a weighted signal; and
transmitting said weighted signal to said remote node from said first cooperating node.

2. The method of claim 1, wherein:
transmitting said weighted signal to said remote node from said first cooperating node is performed at substantially the same time that at least one other cooperating node in the plurality of cooperating nodes transmits a weighted signal to said remote node.

3. The method of claim 1, wherein determining a conjugated phase of a channel coefficient includes:
receiving training data from said remote node at said first cooperating node;
using said training data to generate a complex channel coefficient for said channel between said first cooperating node and said remote node; and
determining a phase associated with a complex conjugate of said complex channel coefficient.

4. The method of claim 1, wherein determining a conjugated phase of a channel coefficient includes:
receiving said conjugated phase from said remote node.

5. The method of claim 1, wherein determining a conjugated phase of a channel coefficient includes retrieving said conjugated phase from a memory within said first cooperating node.

6. The method of claim 1, wherein:
said plurality of cooperating nodes is acting as a relay between a source node and a destination node, wherein said source node is said remote node to which said weighted signal is transmitted.

7. The method of claim 1, wherein:
transmitting said weighted signal includes transmitting said weighted signal at a maximum available power.

8. An apparatus comprising:
a wireless transceiver;
a channel determination unit to determine a conjugated phase of a channel coefficient for a wireless channel between said apparatus and a remote wireless node; and
a weighting unit to weight a transmit signal to be transmitted to said remote wireless node with said conjugated phase of said channel coefficient when said apparatus is being used as a cooperating node within a cooperative diversity arrangement having multiple cooperating nodes.

9. The apparatus of claim 8, wherein:
said wireless transceiver is a multicarrier wireless transceiver that is capable of transmitting and receiving signals having a plurality of subcarriers;
said channel determination unit is to determine a conjugated phase of a channel coefficient for multiple different subcarriers; and
said weighting unit is to weight multiple different subcarriers of a transmit signal using conjugated phases of corresponding channel coefficients.

10. The apparatus of claim 8, wherein:
said channel determination unit is to estimate a channel coefficient for said wireless channel between said apparatus and said remote wireless node based on training data received from said remote wireless node.

11. The apparatus of claim 8, wherein:
said channel determination unit is to determine said conjugated phase of said channel coefficient for said wireless channel by receiving said conjugated phase from said remote wireless node.

12. The apparatus of claim 8, further comprising:
a memory to store said conjugated phase of said channel coefficient for use by said weighting unit.

13. The apparatus of claim 8, further comprising:
a cooperative diversity manager to manage the performance of cooperative diversity functions.

14. The apparatus of claim 8, wherein:
said cooperative diversity arrangement includes a source node and a destination node in addition to said multiple cooperating nodes, wherein said remote wireless node to which said transmit signal is to be transmitted is said source node.

15. The apparatus of claim 8, wherein:
said wireless transceiver transmits said weighted transmit signal at substantially the same time that at least one other cooperating node within said cooperative diversity arrangement is transmitting a corresponding weighted transmit signal.

16. A system comprising:
a dipole antenna;
a wireless transceiver coupled to said dipole antenna;
a channel determination unit to determine a conjugated phase of a channel coefficient for a wireless channel between said apparatus and a remote wireless node; and
a weighting unit to weight a transmit signal to be transmitted to said remote wireless node with said conjugated phase of said channel coefficient when said system is being used as a cooperating node within a cooperative diversity arrangement having multiple cooperating nodes.

17. The system of claim 16, wherein:
said wireless transceiver is a multicarrier wireless transceiver that is capable of transmitting and receiving signals having a plurality of subcarriers;
said channel determination unit is to determine a conjugated phase of a channel coefficient for multiple different subcarriers; and
said weighting unit is to weight multiple different subcarriers of a transmit signal using conjugated phases of corresponding channel coefficients.

18. The system of claim 16, wherein:
said channel determination unit is to estimate a channel coefficient for said wireless channel between said system and said remote wireless node based on training data received from said remote wireless node.

19. The system of claim 16, wherein:
said channel determination unit is to determine said conjugated phase of said channel coefficient for said wireless channel by receiving said conjugated phase from said remote wireless node.

20. An article comprising a storage medium having instructions stored thereon that, when executed by a computing platform, operate to:
determine a conjugated phase of a channel coefficient for a channel between a first cooperating node and a remote node in a cooperative diversity arrangement having a plurality of cooperating nodes;
weight a signal to be transmitted to said remote node from said first cooperating node using said conjugated phase of said channel coefficient, but not a magnitude of said channel coefficient, to generate a weighted signal; and
transmit said weighted signal to said remote node from said first cooperating node.

21. The article of claim 20, wherein:
operation to transmit said weighted signal to said remote node from said first cooperating node is performed at substantially the same time that at least one other cooperating node in the plurality of cooperating nodes transmits a weighted signal to said remote node.

22. The article of claim 20, wherein operation to determine a conjugated phase of a channel coefficient includes operation to:
receive training data from said remote node at said first cooperating node;
use said training data to generate a complex channel coefficient for said channel between said first cooperating node and said remote node; and
determine a phase associated with a complex conjugate of said complex channel coefficient.

23. The article of claim 20, wherein operation to determine a conjugated phase of a channel coefficient includes operation to:
receive said conjugated phase from said remote node.

24. The article of claim 20, wherein operation to determine a conjugated phase of a channel coefficient includes operation to retrieve said conjugated phase from a memory within said first cooperating node.

25. The article of claim 20, wherein:
operation to transmit said weighted signal includes operation to transmit said weighted signal at a maximum available power.
